(19) United States
(12) Patent Application Publication
(10) Pub. No.: US 2008/0165654 A1
(43) Pub. Date: Jul. 10, 2008

(54) HOLOGRAPHIC INFORMATION RECORDING AND REPRODUCING APPARATUS

(75) Inventor: Takashi Fukuhara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/965,184

(22) Filed: Dec. 27, 2007

(30) Foreign Application Priority Data
Jan. 10, 2007 (JP) 2007-002290

(51) Int. Cl. G11B 7/00

(52) U.S. Cl. 369/103

(57) ABSTRACT

A holographic information recording and reproducing apparatus, comprising a light source; a beam splitter for splitting a beam emitted from the light source into a first beam and a second beam; a spatial light modulator for providing the first beam with information; a first mirror for causing the second beam to be incident on a transmission type information recording medium; a second mirror for causing the second beam that has passed through the information recording medium to be incident on the information recording medium again; a photodetector for detecting the second beam which is caused to be incident on the information recording medium again and exits from the information recording medium toward the first mirror; and a controller for controlling an angle of the second mirror based on a detection result of the photodetector.

### BACKGROUND OF THE INVENTION

1. Field of the Invention

The present invention relates to a holographic information recording and reproducing apparatus, and more particularly, to a holographic information recording and reproducing apparatus capable of detecting an angle signal and conducting correction.

2. Description of the Related Art

According to ordinary holographic recording technique for recording information onto a recording medium using holography, a beam having image information and a reference beam are superimposed on each other in an inner portion of the recording medium to write an interference fringe onto the recording medium.

When information is to be reproduced, the recording medium is irradiated with the reference beam to reproduce the image information by the diffraction of the interference pattern.

In recent years, in order to realize super-high density recording, volume holography, in particular, digital volume holography has been under practical development and has been attracting an attention.

The volume holography is a system for three-dimensionally writing an interference fringe onto a recording medium by making active use of a thickness direction thereof. Diffraction efficiency can be improved by an increase in thickness, and recording capacity can be increased using multiple recording.

The digital volume holography is a holographic recording system in which image information to be recorded is limited to a binarized digital pattern while the same recording medium and recording system as those in the case of the volume holography are used.

In the digital volume holography, for example, even image information such as an analog picture is temporarily developed to two-dimensional digital pattern information (page data) by digitization. The digital pattern information is recorded as the image information.

At the time of reproduction, the digital pattern information is read out and decoded to obtain the original image information to be displayed.

Therefore, even in the case where the signal to noise ratio (SN ratio) is relatively low, performing differential detection or encoding binarized data for error correction enables a highly faithful reproduction.

Techniques of slightly changing an angle of a reference beam relative to a signal beam on a recording layer of the recording medium at the time of recording to perform multiple recording of different recording information in the same area have been proposed for means for recording and reproducing the information.

There is a technique described in 2006 Optical Data Storage Topical Meeting Conference Proceedings MA1, “The InPhase Professional Archive Drive OMA: Design and Function” as a known technique.

FIGS. 5 and 6 are block diagrams illustrating a structure of a conventional holographic information recording and reproducing apparatus.

A beam emitted from a light source 1 whose wavelength is 405 nm is adjusted in beam diameter by a main expander 2 and then incident on an apodizer 3 to obtain an isotropic distribution of quantity of light.

The beam passes through a movable half-wave plate 4 and is split into an information beam 6 and a reference beam 7 by a polarization beam splitter 5.

The movable half-wave plate 4 is rotated to adjust the polarization direction of the beam, thereby changing the intensity balance between the information beam 6 and the reference beam 7.

The information beam 6 obtained by splitting is beam-shaped by a beam expander 8 and passes through a phase mask 9 for obtaining a uniform intensity distribution on the Fourier plane. Then, the information beam 6 passes through a relay lens 10 and is reflected by a polarization beam splitter 11 to travel toward an SLM 12. Note that the SLM 12 is a spatial light modulator and has a structure including a glass substrate, a liquid crystal member, and an electrode substrate. The electrode substrate is controlled to adjust reflectance for each pixel, thereby producing a desirable signal beam pattern on the information beam.

The information beam 6 is modulated by the SLM 12. The polarization direction of the signal beam provided with information is rotated by π/2. The signal beam then passes through the polarization beam splitter 11.

After that, the signal beam passes through a polytopic filter 13 (its effect will be described later), relay lenses 14, and a movable half-wave plate 15 and is incident on a storage lens 16 to focus on a disk 21.

Note that the polarization direction of the beam is not rotated by the movable half-wave plate 15 at the time of recording.

The reference beam 7 passes through a polarization beam splitter 5. Then, the reference beam 7 is reflected on a mirror 17 and a mirror 18 and deflected in a desirable direction by a rotational mirror 19.

The beam incident on a scanner lens 20 passes through a recording position of the disk 21 irrespective of the deflection direction adjusted by the rotational mirror 19

In other words, the incident angle of the reference beam 7 with respect to the recording position of the disk 21 is changed by the rotation of the rotational mirror 19 to perform angular multiple recording.

The disk is exposed to the interference pattern for recording information.

On the other hand, at the time of reproduction, the beam emitted from the light source 1 whose wavelength is 405 nm is adjusted in beam diameter by the main expander 2 and then incident on the apodizer 3 to obtain an isotropic distribution of quantity of light.

The movable half-wave plate 4 is tilted such that the beam is not reflected by the polarization beam splitter 5 but passes therethrough.

After that, the beam is reflected on the mirror 17, the mirror 18, and the rotational mirror 19 and passes through the scanner lens 20 and the disk 21. Then, the beam is reflected on a turning rotational mirror 22 to travel back along the same optical path.

A reconstruction beam 23 reconstructed from the reference beam 7 which is incident on the disk 21 from a direction opposite to that at the time of recording is converted into a parallel beam by the storage lens 16. The polarization direction of the reconstruction beam 23 is changed by π/2 by the movable half-wave plate 15.

An unnecessary reconstruction beam reproduced simultaneously with a desirable reconstruction beam has different focal points in the plane perpendicular to the optical axis between the relay lenses 14. Therefore, the unnecessary reconstruction beam is removed by the polytopic filter 13 which causes only the desirable reconstruction beam to pass therethrough.

The reconstruction beam is reflected by the polarization beam splitter 11 to be guided to a CMOS sensor 24. The CMOS sensor 24 detects a signal to reproduce the information.

In such a case, the rotation of the turning rotational mirror 22 is normally adjusted such that the intensity of the reproduction signal incident on the CMOS sensor 24 becomes maximum, thereby performing angle control of the reference beam 7 (2006 Optical Data Storage Topical Meeting Conference Proceedings MP4, “The Angle Align Method of Reference Beam for Holographic Data Storage”).

However, a conventional holographic information recording and reproducing apparatus has the following problem.

In a conventional technique, the reference beam 7 is occasionally incident on the disk 21 at an incident angle different from a desirable incident angle because of a vibration of an optical bench or a vibration caused by hand movement when the holographic information recording and reproducing apparatus is used as a mobile device.

With such incident angle different from the desirable incident angle, there is the possibility that the angle of the turning rotational mirror 22 is adjusted to such an angle that the signal intensity is maximum.

Therefore, there is the possibility that the angle of the turning rotational mirror 22 cannot be corrected to a desirable angle. Thus, there is a case where the desirable reconstruction beam 23 is not stably obtained.

### SUMMARY OF THE INVENTION

It is an object of the present invention to provide a holographic information recording and reproducing apparatus capable of detecting an angle signal and conducting correction even when an angle of a turning rotational mirror is deviated from a desirable angle because of a vibration or the like.

The present invention provides a holographic information recording and reproducing apparatus, including: a light source; a beam splitter for splitting a beam emitted from the light source into a first beam and a second beam; a spatial light modulator for providing the first beam with information; a first mirror for causing the second beam to be incident on a transmission type information recording medium; a second mirror for causing the second beam that has passed through the information recording medium to be incident on the information recording medium again; a photodetector for detecting the second beam which is caused to be incident on the information recording medium again and exits from the information recording medium toward the first mirror; and a controller for controlling an angle of the second mirror based on a detection result of the photodetector.

Further features of the present invention will become apparent from the following description of exemplary embodiments with reference to the attached drawings.

### BRIEF DESCRIPTION OF THE DRAWINGS

FIG. 1 is a block diagram illustrating a structure of a holographic information recording and reproducing apparatus according to a first embodiment of the present invention.

FIG. 2 is a block diagram illustrating a photodetector for detecting a rotation angle deviation signal of a turning rotational mirror and a rotation angle control circuit in an embodiment of the present invention.

FIG. 3 is a graph illustrating a detection signal of the photodetector which is generated based on a rotation angle deviation of the turning rotational mirror in an embodiment of the present invention.

FIG. 4 is a block diagram illustrating a structure of a holographic information recording and reproducing apparatus according to a second embodiment of the present invention.

FIG. 5 is a block diagram illustrating a structure of a conventional holographic information recording and reproducing apparatus in the case of recording.

FIG. 6 is a block diagram illustrating a structure of the conventional holographic information recording and reproducing apparatus in the case of reproduction.

### DESCRIPTION OF THE EMBODIMENTS

Hereinafter, exemplary embodiments for embodying the present invention will be described in detail with reference to the attached drawings.

### First Embodiment

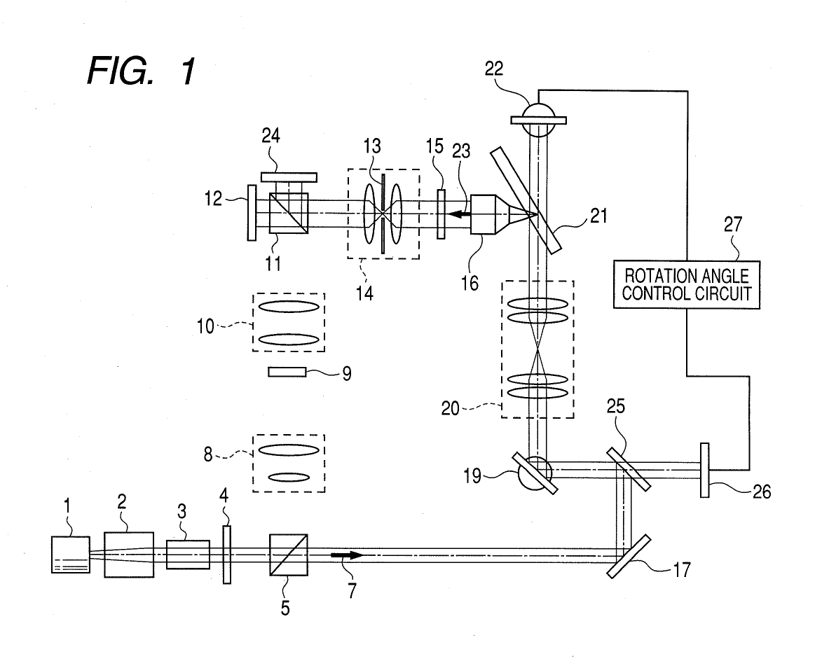

A first embodiment of the present invention will be described with reference to FIGS. 1, 2, and 3.

FIG. 1 is a block diagram illustrating a structure of a holographic information recording and reproducing apparatus according to the first embodiment of the present invention in the case where information is reproduced.

In FIG. 1, the holographic information recording and reproducing apparatus includes a light source 1, a main expander 2 serving as an expander, an apodizer 3, movable half-wave plates 4 and 15, and polarization beam splitters 5 and 11 each serving as a beam splitter. Reference numeral 6 denotes an information beam and 7 denotes a reference beam. The holographic information recording and reproducing apparatus further includes a beam expander 8, a phase mask 9, relay lenses 10 and 14, a spatial light modulator (SLM) 12, a polytopic filter 13, a storage lens 16, and mirrors 17 and 18. The holographic information recording and reproducing apparatus further includes a rotational mirror 19 serving as a first mirror, a scanner lens 20, a turning rotational mirror 22 serving as a second mirror, a CMOS sensor 24, and a beam splitter 25. Reference numeral 21 denotes a disk serving as an information recording medium and 23 denotes a reconstruction beam. The holographic information recording and reproducing apparatus further includes a double-split photodetector 26, a rotation angle control circuit 27 serving as a control unit, and a lens 28.

A beam emitted from the light source 1 whose wavelength is 405 nm is adjusted in beam diameter by the main expander 2 and then incident on the apodizer 3 to obtain an isotropic distribution of quantity of light. The movable half-wave plate 4 is tilted such that the beam is not reflected by the polarization beam splitter 5 but passes therethrough.

After that, the beam is reflected by the mirror 17, the beam splitter 25, and the rotational mirror 19 and passes through the scanner lens 20 and the disk 21. Then, the beam is reflected by the turning rotational mirror 22 to travel back on the same optical path.

The beam reflected on the turning rotational mirror 22 passes through the disk 21 and the scanner 20 again and is reflected on the rotational mirror 19. Then, the beam passes through the beam splitter 25 and is detected by the double-split photodetector 26.

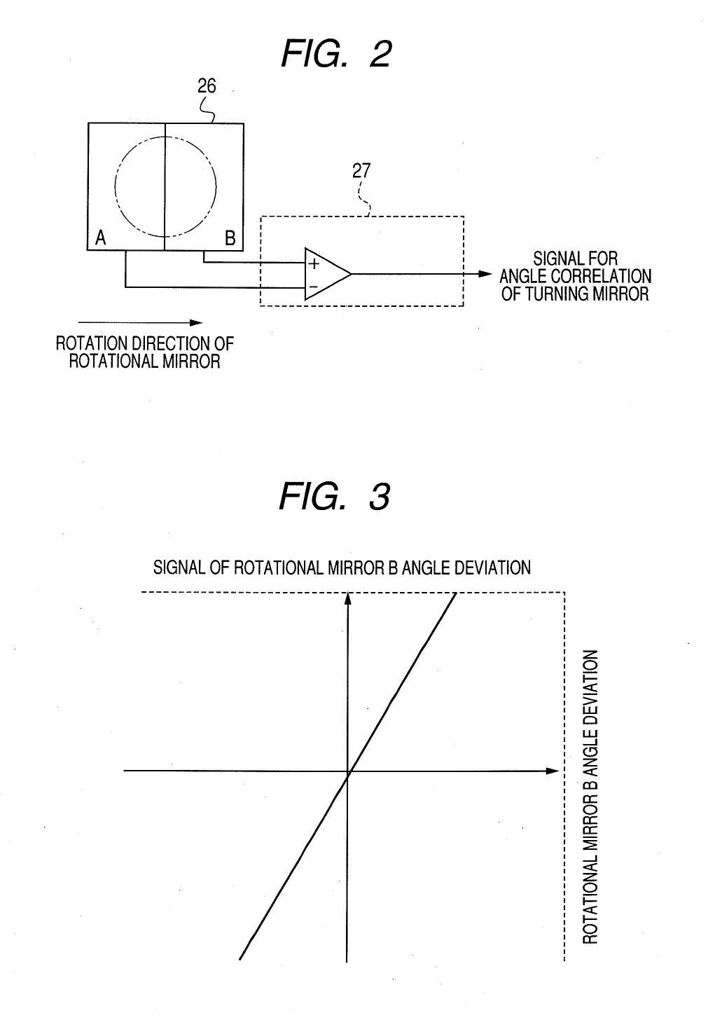

As shown in FIG. 2, the double-split photodetector 26 is divided into a region A and a region B which are arranged in a direction perpendicular to a rotation direction of the rotational mirror 19.

When the rotation angle of the turning rotational mirror 22 is deviated by a disturbance such as a vibration of an optical bench, a light spot moves on the double-split photodetector 26.

Therefore, as shown in FIG. 2, a difference between signals from the respective regions located on the double-split photodetector 26 is calculated using Expression 1 by the rotation angle control circuit 27 to obtain the angle deviation signal of the turning rotational mirror 22 with respect to the rotational mirror 19 (FIG. 3).

“Angle deviation signal”=A−B (Expression 1)

The angle of the turning rotational mirror 22 is corrected based on the angle deviation signal, so a desirable reproduction signal with respect to the incident angle determined by the rotational mirror 19 is obtained. That is, when the angle deviation signal approaches 0, the direction of a beam incident on the disk 21 from the mirror 17 becomes opposite to the direction of a beam caused to be incident on the disk 21 again by the rotational mirror 19. According to such control, the beam can be caused to be incident on the disk 21 again at a desirable incident angle.

The reconstruction beam 23 reconstructed from the reference beam 7 which is reflected on the turning rotational mirror 22 and is incident on the disk 21 from a direction opposite to a direction at the time of recording is converted into a parallel beam by the storage lens 16. The polarization direction of the reconstruction beam 23 is changed by π/2 by the movable half-wave plate 15.

An unnecessary reconstruction beam reproduced simultaneously therewith a desirable reconstruction beam is different in focal point in the plane perpendicular to the optical axis between the relay lenses 14. Therefore, the unnecessary reconstruction beam is removed by the polytopic filter 13 which causes only the desirable reconstruction beam to pass therethrough.

The reconstruction beam is reflected by the polarization beam splitter 11 to be guided to the CMOS sensor 24. The CMOS sensor 24 detects a signal to reproduce the information.

### Second Embodiment

A second embodiment of the present invention will be described with reference to FIGS. 2, 3, and 4.

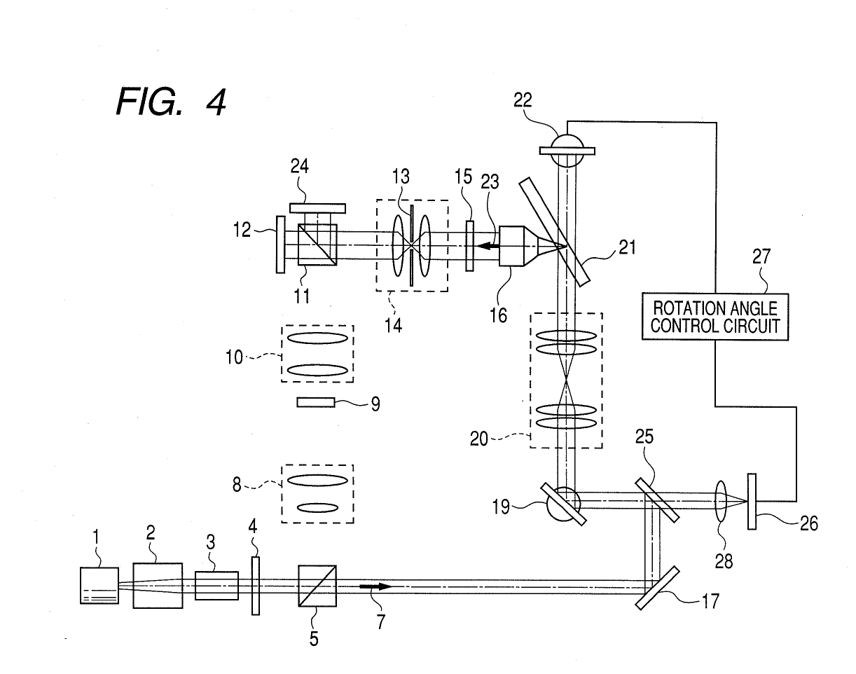

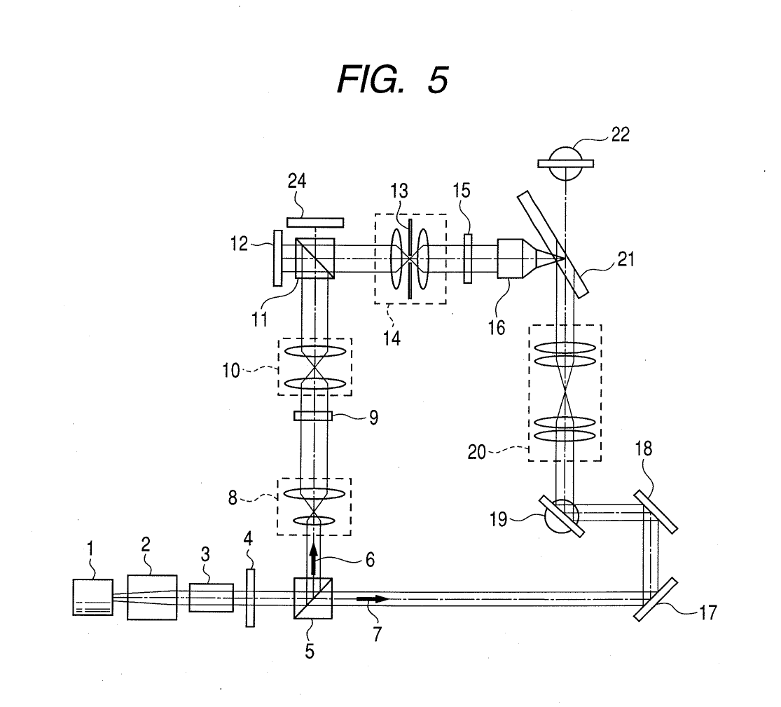

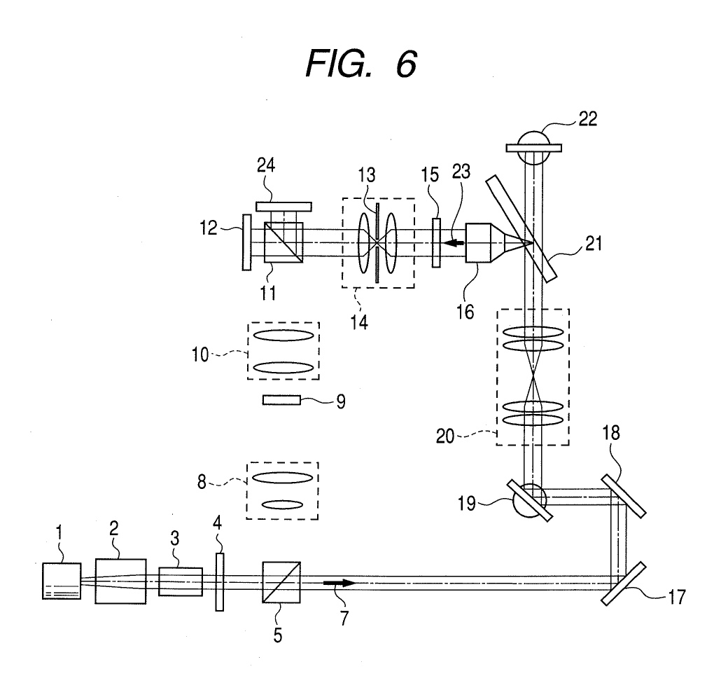

FIG. 4 is a block diagram illustrating a structure of a holographic information recording and reproducing apparatus according to the second embodiment of the present invention in the case where information is reproduced.

FIG. 4 is different from FIG. 1 in that a lens 28 is disposed between the photodetector 26 and the beam splitter 25. A beam focused by the lens 28 is detected by the photodetector 26 to detect a position of the beam.

As shown in FIG. 4, a beam emitted from the light source 1 whose wavelength is 405 nm is adjusted in beam diameter by the main expander 2 and then incident on the apodizer 3 to obtain an isotropic distribution of quantity of light.

The movable half-wave plate 4 is tilted such that the beam is not reflected by the polarization beam splitter 5 but passes therethrough.

After that, the beam is reflected by the mirror 17, the beam splitter 25, and the rotational mirror 19 and passes through the scanner lens 20 and the disk 21. Then, the beam is reflected by the turning rotational mirror 22 to travel back on the same optical path.

The beam reflected on the turning rotational mirror 22 passes through the disk 21 and the scanner 20 again and is reflected on the rotational mirror 19. Then, the beam passes through the beam splitter 25, is incident on the lens 28, and is detected by the double-split photodetector 26.

As shown in FIG. 2, the double-split photodetector 26 is divided into a region A and a region B which are arranged in a direction perpendicular to a rotation direction of the rotational mirror 19.

When the rotation angle of the turning rotational mirror 22 is deviated by θ due to a disturbance such as a vibration of an optical bench, the optical axis of a reflected beam is tilted by 2θ with respect to the optical axis of the incoming beam.

A light spot on the double-split photodetector 26 shifts by “f×sin 2θ” (f is a focal length of the lens 28) relative to a reference position (spot position in the case of θ=0, that is, the center of the detector).

A difference between signals from the respective regions located on the double-split photodetector 26 is calculated using Expression 1 by the rotation angle control circuit 27. Therefore, even when the intensity of a returned beam is weak, the angle deviation signal of the turning rotational mirror 22 with respect to the rotational mirror 19 is obtained (FIG. 3).

The angle of the turning rotational mirror 22 is corrected based on the signal, so a desirable reproduction signal with respect to an incident angle determined by the rotational mirror 19 is obtained.

The reconstruction beam 23 reconstructed from the reference beam 7 which is reflected on the turning rotational mirror 22 and is incident on the disk 21 from a direction opposite to a direction at the time of recording is converted into a parallel beam by the storage lens 16. The polarization direction of the reconstruction beam 23 is changed by π/2 by the movable half-wave plate 15.

An unnecessary reconstruction beam reproduced simultaneously with a desirable reconstruction beam is different in focal point in the plane perpendicular to the optical axis between the relay lenses 14. Therefore, the unnecessary reconstruction beam is removed by the polytopic filter 13 which causes only the desirable reconstruction beam to pass therethrough.

The reconstruction beam is reflected by the polarization beam splitter 11 to be guided to the CMOS sensor 24. The CMOS sensor 24 detects a signal to reproduce the information.

As described above, according to the present invention, even when the angle of the turning rotational mirror is deviated from a desirable angle because of a vibration of an optical bench or a vibration caused by hand movement, the angle signal is detected to correct the angle.

Therefore, even when the angle of the reference beam reflected on the turning rotational mirror is deviated to such an angle that an unnecessary reconstruction beam is produced, the angle of the turning rotational mirror can be corrected to a desirable angle to perform accurate information reproduction.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-002290, filed Jan. 10, 2007, which is hereby incorporated by reference in its entirety.

What is claimed is:

1. A holographic information recording and reproducing apparatus, comprising:
a light source;
a beam splitter for splitting a beam emitted from the light source into a first beam and a second beam;
a spatial light modulator for providing the first beam with information;
a first mirror for causing the second beam to be incident on a transmission type information recording medium;
a second mirror for causing the second beam that has passed through the information recording medium to be incident on the information recording medium again;
a photodetector for detecting the second beam which is caused to be incident on the information recording medium again and exits from the information recording medium toward the first mirror; and
a controller for controlling an angle of the second mirror based on a detection result of the photodetector.

2. A holographic information recording and reproducing apparatus according to claim 1, wherein the photodetector has a beam irradiation surface divided into at least two.

3. A holographic information recording and reproducing apparatus according to claim 1, wherein the photodetector detects a beam reflected by the first mirror.

4. A holographic information recording and reproducing apparatus according to claim 3, further comprising a lens provided between the first mirror and the photodetector.

5. A holographic information recording and reproducing apparatus according to claim 1, wherein the controller controls the second mirror so that a direction of the second beam incident on the information recording medium is opposite to a direction of the second beam incident on the information recording medium again.
